(19) United States
(12) Patent Application Publication
(10) Pub. No.: US 2012/0232949 A1
(43) Pub. Date: Sep. 13, 2012

(54) Tracking and Using Clinical Trial Protocol Feasibility Information

(76) Inventors: Helen Mary Lingard, Cary, NC (US); Dawn Michelle Anderson, Raleigh, NC (US); Sarah Louise Bass-Charlesworth, Middlesex (GB)

(21) Appl. No.: 13/046,295

(22) Filed: Mar. 11, 2011

(51) Int. Cl. G06Q 10/04

(52) U.S. Cl. 705/7.28

(57) ABSTRACT

Systems and methods are disclosed for managing information from a feasibility study of a clinical trial protocol. Data relationships in a database can be utilized to, for example, formulate bids for managing a clinical trial protocol, track information about a feasibility study, output reminder notifications regarding overdue documents in connection with the feasibility study, provide information for use in site start-up or other processes implemented in conducting the clinical trial protocol, and allow feasibility study information to be analyzed after a clinical trial protocol has been conducted.

### FIELD

This disclosure relates generally to computer software for clinical trial management that runs, displays, provides, or otherwise uses electronic content and more particularly (although not necessarily exclusively) to computer software for managing the generation, tracking, storage, and use of feasibility information developed from feasibility studies associated with clinical trials.

### BACKGROUND

Clinical trials are conducted in accordance with a clinical trial protocol to allow safety and efficacy data to be collected for health interventions such as drugs, diagnostics, devices and therapy protocols. It is often desirable to conduct a feasibility study for a clinical trial protocol prior to (or in conjunction with) conducting the clinical trial protocol. A feasibility study may be conducted in response to a request from a customer of a clinical research organization (CRO). Conducting the clinical trial protocol can include implementing a clinical trial in accordance with the protocol. A feasibility study can be used to determine if a sufficient number of subjects can be recruited throughout one or more geographic boundaries (such as countries) and whether sufficient data can be generated to analyze a protocol sufficiently. A subject can include a patient or other individual that participates in the implementation of the clinical trial protocol. A feasibility study can be conducted by a CRO prior to bidding on the clinical trial protocol to assist in formulating parameters of the bid.

In connection with a feasibility study, investigators (also known as “sites” or “doctors”) are contacted to gather information for the feasibility study. The information can include whether an investigator is interested in conducting the clinical trial protocol and, if so, an estimated number of subjects that the investigator estimates that he or she can recruit for the clinical trial protocol. Confidential disclosure agreement (CDA) and survey documents may be sent to investigators. The information from the investigators can be used to determine whether the clinical trial protocol would be viable.

Often feasibility information is stored for a specific bid or feasibility study locally (i.e. at a CRO location in a country in which the feasibility study was conducted) and using basic storage mechanisms such as a Microsoft Excel™ spreadsheet application available from Microsoft Corp. It is difficult, and in some cases impossible, to share information from a completed feasibility study for other purposes because the information is stored locally using basic storage mechanisms.

For example, CRO personnel in another location, such as in another country, conducting a subsequent feasibility study on a different (but similar) clinical trial protocol may not have access to the information, which can be useful in formulating a bid or otherwise analyzing the feasibility of the subsequent clinical trial protocol. Furthermore, CRO personnel different than personnel that conduct feasibility studies often manage site start-up and other phases of conducting clinical trial protocols. Personnel conducting clinical trial protocols often do not have access to the feasibility information and must “re-invent the wheel” by identifying, again, investigators to conduct a clinical trial protocol and send and receive documents, such as CDAs and surveys. For example, an investigator that executed a CDA for a clinical trial protocol during the feasibility study may be sent another CDA for execution. Such inefficiencies are undesirable. In addition, due to inaccessible feasibility information, it can be difficult or impossible to compare data obtained from conducting a clinical trial protocol to information obtained or determined during a feasibility study.

Accordingly, systems and methods are desirable that can better facilitate management of feasibility study information.

### SUMMARY

Systems and methods are disclosed for managing feasibility study information. In one aspect, attributes of an investigator are received. The attributes include an identification of the investigator. A unique identifier (UID) is associated with the attributes of the investigator and the UID is stored in a database. A search request is received that includes a search variable corresponding to at least one attribute of the investigator. The attribute of the investigator is outputted in response to the search request. A selection is received for a feasibility study of a clinical trial protocol of the attribute of the investigator outputted. A computing device executing code tracks receipt of at least one document from the investigator and associates receipt of the document with the UID in the database. The document is associated with the feasibility study.

Another aspect is a system that includes a first database, a second database, and a database server stored on a first non-transitory computer-readable medium. The first database includes the first non-transitory computer-readable medium. The first non-transitory computer-readable medium can store a first UID associated with attributes of a first investigator contacted in connection with a feasibility study of a clinical trial protocol and a flag indicating receipt of an executed confidentiality agreement from the first investigator. The first non-transitory computer-readable medium can also associate the first UID with a record of the clinical trial protocol. The attributes of the first investigator include an identification of the first investigator. The second database includes a second non-transitory computer-readable medium that can store second attributes of a second investigator associated with a previous record of a previous clinical protocol in which the second investigator participated. The database server application is executable by a processor to receive the second attributes of the second investigator and associated a second UID with the second attributes of the second investigator and with the previous record in the first database. The database server application is also executable by the processor to track receipt of a second executed confidentiality agreement from the second investigator.

Another aspect is a non-transitory computer-readable medium tangibly embodying executable code. The code includes code for receiving attributes of an investigator. The attributes include an identification of the investigator. The code also includes code for associating a UID with the attributes of the investigator and storing the UID in a database. The code also includes code for receiving a search request that includes a search variable corresponding to at least one attribute of the investigator. The code also includes code for outputting the attribute of the investigator in response to the search request. The code also includes code for receiving a selection for a feasibility study of a clinical trial protocol of the attribute of the investigator outputted. The code also includes code for tracking receipt of at least one document from the investigator and associating receipt of the document with the UID in the database.

These illustrative aspects are mentioned not to limit or define the disclosure, but to provide examples to aid understanding thereof. Additional aspects and embodiments are discussed in the Detailed Description, and further description is provided there. Advantages offered by one or more of the various aspects and embodiments may be further understood by examining this specification or by practicing one or more aspects and embodiments presented.

### BRIEF DESCRIPTION OF THE FIGURES

These and other features, aspects, and advantages of the present disclosure are better understood when the following Detailed Description is read with reference to the accompanying drawings, where:

FIG. 1 is a block diagram of a system for managing feasibility study information according to one embodiment;

FIG. 2 is a flow chart of a method for managing feasibility study information according to one embodiment;

FIG. 3 is a flow chart of a method for tracking documents in a feasibility study according to one embodiment;

FIG. 4 is a database architecture diagram of relationships between investigator records and clinical trial protocol records according to one embodiment;

FIG. 5 is a flow chart of a method for integrating investigator information from a second database according to one embodiment;

FIG. 6 is a flow chart of a method for comparing actual data to estimated data in feasibility study information according to one embodiment;

FIG. 7 is a user interface for tracking a confidential disclosure agreement (CDA) in a feasibility study according to one embodiment;

FIG. 8 is a user interface for tracking a survey and a CDA according to one embodiment; and

FIG. 9 is a user interface for tracking receipt of the survey referenced in FIG. 8 according to one embodiment.

### DETAILED DESCRIPTION

Certain features of the present disclosure include systems and methods for managing information from a feasibility study of a clinical trial protocol. Data relationships in a database can be utilized to formulate bids for managing a clinical trial protocol, track information about a feasibility study, output reminder notifications regarding overdue receipt of documents in connection with the feasibility study, provide information for use in site start-up or other processes implemented in conducting the clinical trial protocol, and/or allow feasibility study information to be analyzed after a clinical trial protocol has been conducted.

A system implementing certain features of the present disclosure outputs a user interface to receive attributes from clinical research organization (CRO) personnel, or the system receives investigator identifications and/or from other sources. Examples of investigator attributes include identification of the investigator, contact information, therapeutic area of specialization (e.g. experience category), number of clinical trials previously conducted, therapeutic area for each clinical trial previously conducted, medical indication (e.g. experience) for each clinical trial previously conducted, previous subject recruitment performance, other subject population data, and presence or absence on a derogatory list. A derogatory list may be list of investigators disbarred by a government entity, such as the Federal Drug Administration (FDA). Examples of contact information include first name, last name, contact type that identifies the contact (e.g. research nurse, pharmacist, etc.) if it is not the investigator, account name that identifies the research facility to which the investigator is associated, country, region, sub-region, and city.

Examples of other attributes that may be used include partner status identifying a level of partnership with the investigator or associated research organization, contact partner flag that indicates whether the investigator is part of a partnership with the CRO, account partner flag that indicates whether the research facility is part of a partnership with the CRO, good clinical practice (GCP) training date, key opinion leader flag, account type that indicates the type of research facility, CRO cluster name, ethics type that identifies the type of ethics committee used by the research facility, and number of beds at the research facilities. Examples of additional attributes that may be used include clinical experience flag indicating that the investigator has clinical experience, research experience flag indicating that the investigator has clinical trial research experience, specialty category in which the investigator is qualified, specialty in which the investigator is qualified, whether the investigator is a primary or secondary physician, whether the investigator clinical trial experience is within the last 16 months, the number of protocols performed by the investigator, the number of studies in which the investigator performed, median subjects enrolled in a selected indication, median of subject enrollment factor for a selected indication, median of subjects enrolled for all projects, median of subject enrollment in all projects, median start-up factor (e.g. speed of set-up) for all projects, and additional information.

Various types of feasibility studies can be conducted for various purposes. A feasibility study can be conducted to determine if a clinical trial can be conducted according to a clinical trial protocol successfully. Examples of types of feasibility studies that can be conducted include data mining, measuring external (i.e. external to CRO) capability, a full feasibility, measuring internal (i.e. internal to CRO) capability, a paid feasibility, developing proposal text and budget for bidding on managing clinical trials conducted in accordance with a clinical trial protocol, to substantiate a formulated bid, analyzing feasibility after being hired to manage clinical trials conducted in accordance with a protocol, and to rescue implementation of an on-going protocol.

A system according to some embodiments can associate investigator attributes to a clinical trial protocol feasibility study via a unique identifier (UID) assigned to the investigator. For example, when attributes of an investigator (collectively “information”) are received, the system can determine whether a corresponding investigator record exists. If a record does not exist, a UID is created for the investigator and the investigator information is associated to the UID. If the investigator information is received from a second database, such as from a legacy database used to store previous investigator information, the system can update non duplicate information about the investigator from the second database.

The system can receive a search request that includes a search variable matching attribute data for one or more investigators. In response, the system can output an attribute for each of the investigator(s) having attribute data that matches the search variable. CRO personnel or other approved user can review the list to identify investigators that may be suitable to contact for a feasibility study. The system can receive a selection of the one or more of the identified investigators.

A system according to some embodiments can track one or more documents sent to a selected investigator and associate relevant document information to the UID for the investigator. Examples of document information include whether a confidential disclosure agreement (CDA), survey, and/or other document should be sent to the investigator in accordance with applicable clinical trial protocol policies or otherwise, whether a CDA has been sent to the investigator, whether a survey has been sent to the investigator, the type of survey sent, the type of CDA sent, whether an executed CDA has been received, and whether a completed survey has been received.

The UID for a selected investigator can be associated with an identifier for the clinical trial protocol for which a feasibility study is being conducted. Feasibility information, such as the associated investigators, estimated number of subjects for a clinical trial protocol determined at the feasibility stage, and accuracy of the feasibility study, can also be associated with the clinical trial protocol identifier, and the investigator through the UID. Feasibility information is stored in a manner according to some embodiments such that it is easily accessible, which can significantly reduce the time and effort needed for conducting feasibility studies on subsequent, but related, clinical trial protocols. For example, a system according to some embodiments can output feasibility information for completed feasibility studies and associated information in response to a search request for a clinical trial protocol attribute associated with such completed feasibility studies. Examples of clinical trial protocol attributes include therapeutic area and medical indication. The results, which can include investigators contacted and subject population information, (if applicable) can be used in the subsequent feasibility study to estimate subject enrollment and recommend countries in which to conduct the study and/or clinical trial protocol. In addition, the results can be used to identify investigators to contact regarding the subsequent feasibility study or for conducting the subsequent clinical trial protocol.

Systems according to some embodiments can be further enhanced by associating actual clinical trial protocol information (such as an actual number of subjects enrolled in the protocol) to the initial feasibility study. Such association can provide a feedback mechanism by which the feasibility study can be measured. In addition, actual clinical trial protocol information associated with an investigator by the UID can provide the ability to determine the effectiveness of the investigator.

These illustrative examples are given to introduce the reader to the general subject matter discussed here and are not intended to limit the scope of any claim. The following sections describe various additional embodiments and examples with reference to the drawings in which like numerals indicate like elements.

### Illustrative System Implementation

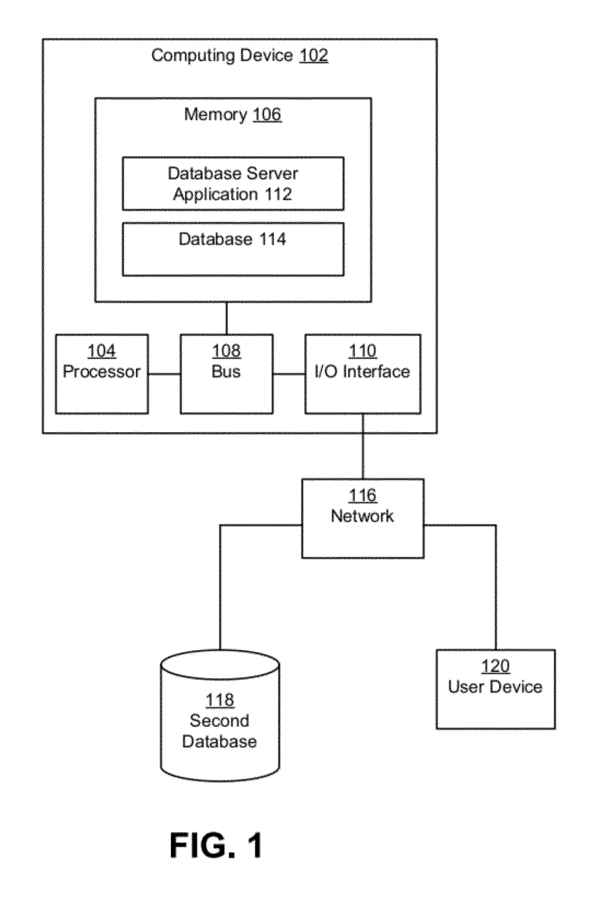

FIG. 1 depicts a system that is capable of managing feasibility study information and associated information according to certain embodiments. Other embodiments may be utilized. The system includes a computing device 102 having a processor 104 that can execute code stored on a computer-readable medium, such as a memory 106, to cause the computing device 102 to manage feasibility study information and associated information. The computing device 102 may be any device that can process data and execute code that is a set of instructions to perform actions. Examples of the computing device 102 include a database server, a web server, desktop personal computer, a laptop personal computer, a server device, a handheld computing device, and a mobile device.

Examples of the processor 104 include a microprocessor, an application-specific integrated circuit (ASIC), a state machine, or other suitable processor. The processor 104 may include one processor or any number of processors. The processor 104 can access code stored in the memory 106 via a bus 108. The memory 106 may be any non-transitory computer-readable medium capable of tangibly embodying code and can include electronic, magnetic, or optical devices. Examples of the memory 106 include random access memory (RAM), read-only memory (ROM), a floppy disk, compact disc, digital video device, magnetic disk, an ASIC, a configured processor, or other storage device. The bus 108 may be any device capable of transferring data between components of the computing device 102. The bus 108 can include one device or multiple devices.

Instructions can be stored in the memory 106 as executable code. The instructions can include processor-specific instructions generated by a compiler and/or an interpreter from code written in any suitable computer-programming language, such as C, C++, C#, Visual Basic, Java, Python, Perl, JavaScript, and ActionScript. The instructions can include a database server application 112 that, when executed by the processor 104, can cause the computing device 102 to manage feasibility study information as explained in more detail below.

Memory 106 can also include a database 114. The database 114 may be a customer relationship management (CRM) database, such as a Siebel CRM database available from Oracle Corp. of Redwood Shores, Calif. In other embodiments, the database 114 is separate from the computing device 102 but in communication with the computing device 102 through an input/output (I/O) interface 110.

The computing device 102 can share data with additional components through the I/O interface 110. The I/O interface 110 can include a USB port, an Ethernet port, a serial bus interface, a parallel bus interface, a wireless connection interface, or any suitable interface capable of allowing data transfers between the computing device and another component. The additional components can communicate with I/O interface 110 over a network 116. The network 116 can include the internet, an intranet, wide area network (WAN), local area network (LAN), virtual private network (VPN), or any suitable communications network that allows computing device 102 to communicate with other components. Network 116 may include one or more networks.

The additional components can include a second database 118 and a user device 120. The second database 118 may be remote from the computing device 102. In some embodiments, the second database 118 can be a legacy database capable of storing as code historical investigator or other type of information. The user device 120 can include a second computing device, such as a laptop or personal computer that is capable of processing commands to output a user interface to a display.

This exemplary system configuration is provided to illustrate configurations of certain embodiments. Other configurations and embodiments may of course be utilized.

### Exemplary Methods of Managing Feasibility Study Information

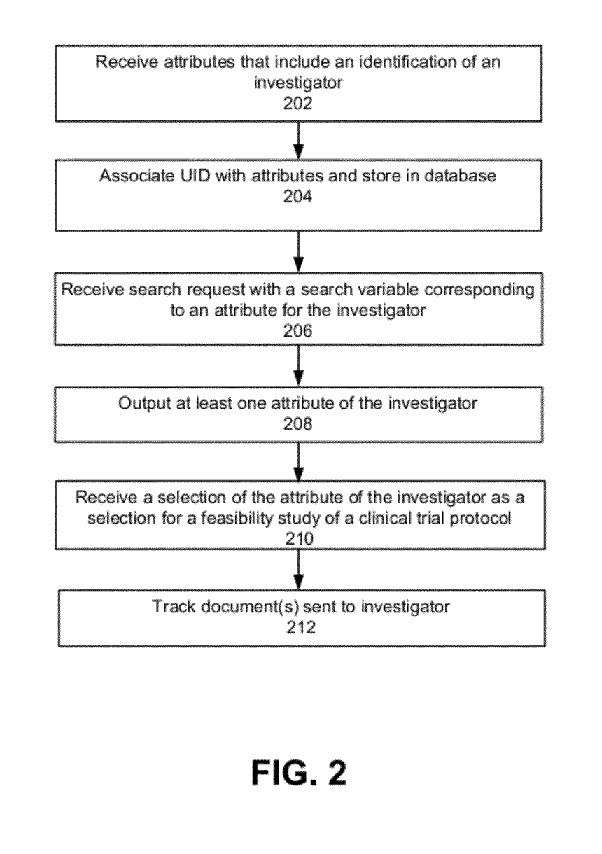

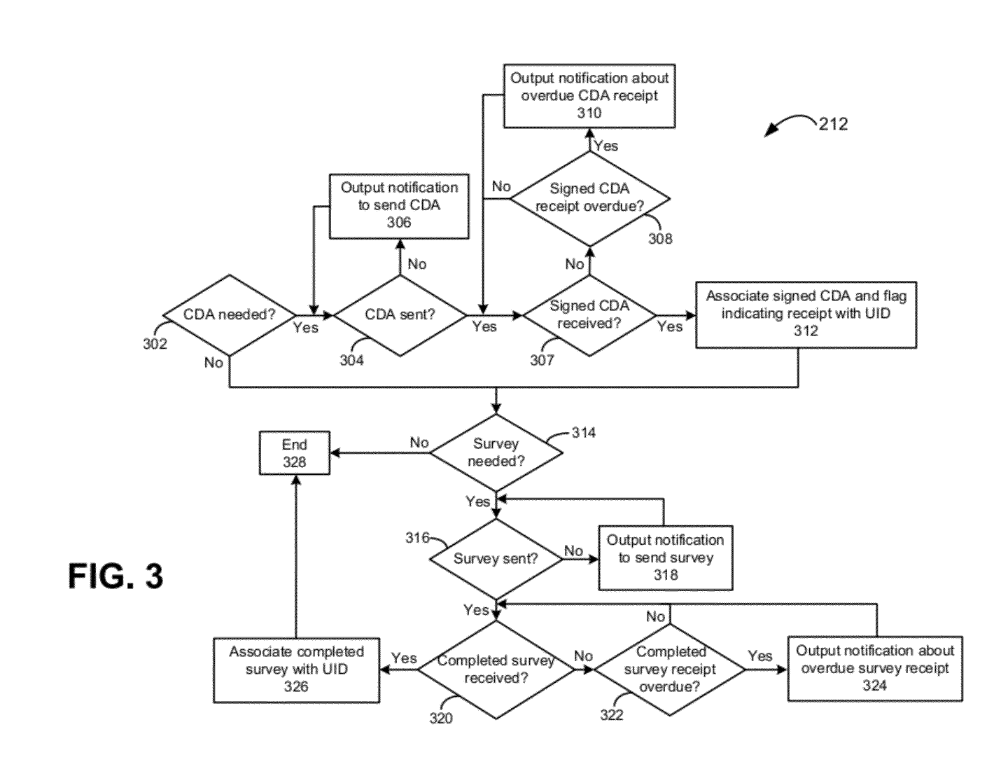

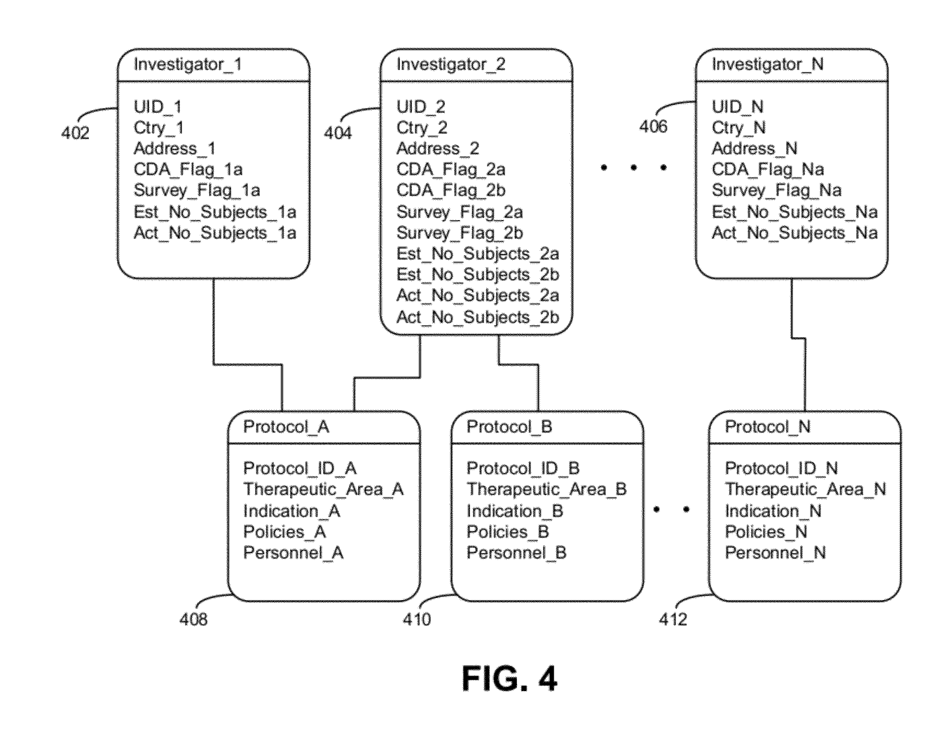

FIG. 2 is a flow diagram that depicts an overall process for managing feasibility study information according to certain embodiments of the present invention. The process is described with reference to the system implementation shown in FIG. 1, database relationship diagram in FIG. 4, and process flow depicted in FIG. 3. Other implementations and processes, however, are possible.

In block 202, the database server application 112 receives attributes of an investigator that include an identification of the investigator. Attributes of more than one investigator can (and is usually) received (as discussed below with reference to FIG. 3), but discussion with respect to FIG. 2 is limited to one investigator for simplicity. Attributes of an investigator can be received from CRO personnel, other approved personnel, a CRO customer, or from a separate system.

In block 204, the database server application 112 associates a UID with the attributes and stores the association in database 114. The database server application 112 can search attributes associated with stored UIDs to determine if the received attributes match attributes associated with a stored UID. If a match is found, the database server application 112 identifies the record in the database 114. If a match is not found, the database server application 112 can generate a new UID and associate the attributes to the new UID.

In block 206, the database server application 112 can receive a search request that includes at least one search variable that corresponds to at least one attribute for the investigator. The search request may include search variables with which the database server application 112 can conduct a search of the database 114. The variables can include an attribute, such as therapeutic area, medical indication or investigator identification, indicating that a user is searching for an investigator associated with these attributes. The database server application 112 can conduct a search of the database 114 using the at least one attribute and a search algorithm.

In response to the search request, the database server application 112 outputs results that can include at least one attribute, such as a name of the investigator, as matching the search request, in block 208. The results may be outputted on a user interface delivered over network 116 to the user device 120 in a format that is displayable by a web browser application or other application being executed on the user device 120.

In block 210, the database server application 112 receives a selection of the attribute of the investigator as a selection for a feasibility study of a clinical trial protocol. For example, the database server application 112 may receive a command from user device 120 to select the identification of the investigator in response to an input from a user, thereby selecting the investigator. In some embodiments, the database server application 112 creates an association in the database 114 between the UID for the investigator and a record for the clinical trial protocol, in response to the selection of the investigator.

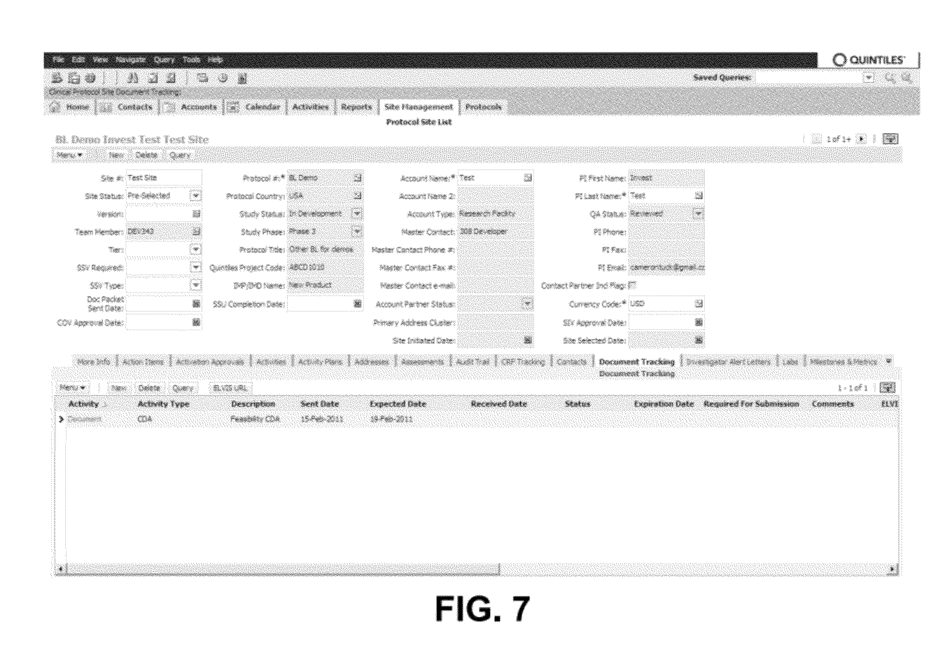

After identifying the investigator, one or more documents associated with the feasibility study can be sent to the investigator. The database server application 112, in block 212, can track the documents sent to the investigator in accordance with the feasibility study, or otherwise. Examples of documents tracked include CDAs, surveys, and other applicable documents. Investigator records and database relationships can facilitate document tracking during and after a feasibility study. FIG. 3 depicts one embodiment of a process for tracking documents that include CDAs and surveys in connection with a feasibility study. The process in FIG. 3 can be applied to other types of documents and at least part of the process can be applied to just one type of document. The process of FIG. 3 is described with reference to FIG. 1 and the user interface depicted in FIGS. 7-9. Other implementations and user interfaces are also possible.

In block 302, the database server application 112 determines whether a CDA should be sent to an investigator. In some embodiments, the database server application 112 analyzes the policies and procedures applicable to the associated clinical trial protocol to determine whether the policies require that a CDA be sent to the investigator. In other embodiments, the database server application 112 receives a command as a user input that a CDA is or is not to be sent to investigators associated with the clinical trial protocol that is subject to the feasibility study. If the database server application 112 determines that a CDA should not be sent to the investigator, the process proceeds to block 314, which will be discussed below.

If the database server application 112 determines that a CDA should be sent to the investigator, the database server application 112 determines whether a CDA has been sent to the investigator in block 304. In some embodiments, the database server application 112 accesses a record for the investigator to determine whether the CDA has been sent. The record can be updated from receiving user input indicating that a CDA has been sent or automatically by monitoring a mail management application that is configured to track outgoing correspondence.

If the database server application 112 determines that a CDA has not been sent, the database server application 112 outputs a notification to relevant CRO personnel to send the CDA in block 306 and, after a pre-set amount of time, returns to block 304. The notification may be an e-mail notification, a user “home page” notification, or a user interface “pop-up” notification outputted to relevant personnel in accordance with associations stored in database 114. In other embodiments, the notification is displayed to a user when the investigator record is accessed.

If the database server application 112 determines that a CDA has been sent to the investigator, the database server application 112 conducts monitoring to determine if an executed (i.e. signed) CDA has been received in block 307. In some embodiments, the database server application 112 monitors database relationships as updated by receiving user input or automatically updated by interfacing with a separate system, such as a mail management application.

If the database server application 112 determines that the executed CDA has not been received, the database server application 112 determines whether receipt of the executed CDA is overdue in block 308. In some embodiments, the database server application 112 is configured with an expected receipt date for an executed CDA. In other embodiments, the database server application 112 automatically determines, by, for example, averaging historical amounts of time between transmission of a CDA and receipt of an executed CDA (i) overall, (ii) for investigators in the same country, or (iii) other factor, an expected receipt date for an executed CDA. If the receipt is not overdue, the database server application 112 returns to block 307 to monitor receipt. If receipt is overdue, the database server application 112 outputs a notification about the overdue CDA to relevant CRO personnel in block 310 and returns to block 307 to monitor receipt. In some embodiments, the database server application 112 receives a “not interested” input from a user and associates the designation with the investigator through the UID.

The database server application 112 can output user interfaces in response to a request to provide an update on CDA document tracking. FIG. 7 depicts an example user interface that can be provided to the user device 120 and displayed to the user. FIG. 7 allows a user to track (i) that a CDA was sent to the associated investigator, (ii) a description of the CDA, (iii) the date on which the CDA was sent to the investigator, and (iv) the expected receipt date. After an executed CDA is received, the user interface can be updated to reflect the date on which the executed CDA was received.

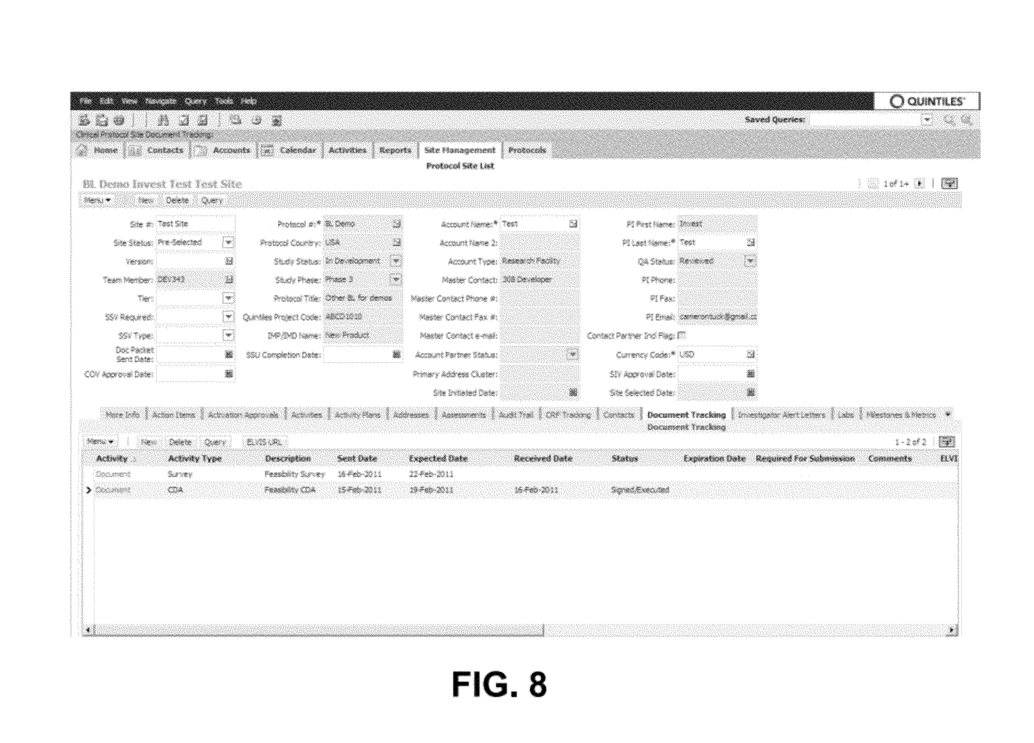

If the database server application 112 determines that an executed CDA has been received, the database server application 112, in block 312, associates the executed CDA and a flag indicating receipt of the executed CDA with the UID of the investigator in the database 114. Examples of a flag indicating receipt of the executed CDA include (i) a visual indicator representing that an executed CDA has been received and (ii) a date on which the CDA was received or executed. The process proceeds to block 314. FIG. 8 depicts an example interface that includes an executed CDA has been received and the actual data of receipt.

The database server application 112 can perform similar tracking with respect to a survey as depicted in blocks 314-326 using the same or similar techniques described above with respect to the CDA. In block 314, the database server application 112 determines whether a survey is needed in accordance, for example, with policies and procedures associated with the clinical trial protocol. If no survey is needed, the process ends in block 328. If a survey is needed, the database server application 112 determines if a survey has been sent in block 316.

If a survey has not been sent, the database server application 112 outputs a notification to relevant CRO personnel to send the survey in block 318. In some embodiments, the database server application 112 outputs sends the survey to the investigator. If a survey has been sent, the database server application 112 determines whether a completed survey has been received in block 320. If a survey has not been received, the database server application 112 determines if receipt is overdue in block 322 and, if so, outputs a notification regarding the overdue receipt. If receipt is not overdue, or otherwise after outputting the notification, the process returns to block 320.

The database server application 112 can also output user interfaces in response to a request to provide an update on the survey document tracking. FIG. 8 depicts an example user interface that can be provided to the user device 120 and displayed to the user. FIG. 8 allows a user to track both a survey and a CDA. With respect to the survey, a user can review the user interface to track (i) that a survey was sent to the associated investigator, (ii) a description of the survey, (iii) the date on which the survey was sent to the investigator, and (iv) the expected receipt date of the survey.

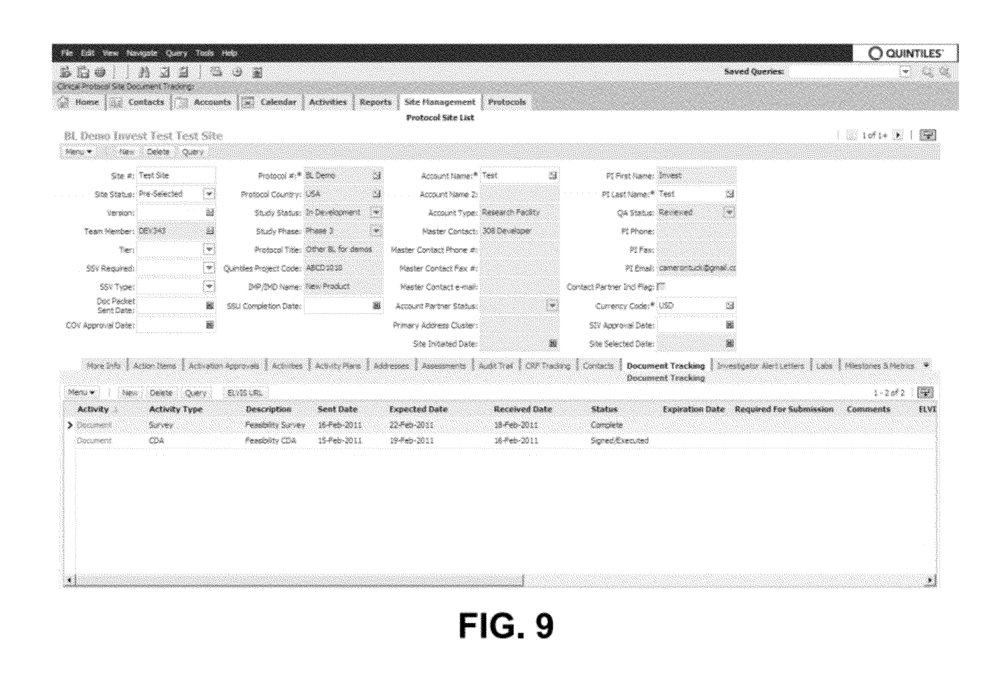

If a completed survey is received, the database server application 112 in block 326 associates the completed survey with the UID in the database 114 and the process ends in block 328. A user interface can be provided in response to a request for a user that indicates that a completed survey has been received. FIG. 9 depicts an example user interface that indicates that the survey referenced in FIG. 8 has been received and the date on which the completed survey was received.

FIG. 4 depicts examples of database associations that can be used to associate investigators with clinical trial protocols and to track one or more documents. FIG. 4 depicts investigator records 402, 404, 406, representing records for investigators 1 to N, and depicts clinical trial protocol records 408, 410, 412, representing records for protocols A to N. An investigator record can be associated with one or more clinical trial protocol records, as illustrated by connecting lines in FIG. 4.

Each investigator record can include fields with data stored therein. For example, record 402 for investigator 1 includes the following fields:
UID (UID_{—}1);
Country of operation of the investigator 1 (Ctry_{—}1);
Address or other contact information for the investigator 1 (Address_{—}1);
An indication that a CDA was sent and received for an associated protocol (CDA_Flag_{—}1a);
An indication that a survey was sent and received for an associated protocol, which may also include the type of feasibility study to which the survey is associated (Survey_Flag_{—}1a);
An estimated number of subjects that the investigator estimates can be recruited by the investigator for an associated protocol, which may be obtained during the feasibility study (Est_No_Subjects_{—}1a); and
An actual number of subjects that the investigator recruited for an associated protocol, which may be blank until the clinical trial protocol is conducted (Act_No_Subjects_{—}1a).
   Other fields may be included. In some embodiments, an investigator record includes additional fields of the same type that are capable of storing data associated with more than one protocol. For example, record 404 is associated with protocol A and protocol B and includes multiple CDA_Flag, Survey_Flag, Est_No_Subjects, and Act_No_Subjects fields.

Each clinical trial protocol record can also include fields with clinical trial protocol attributes stored therein. The attributes for the clinical trial protocol can include therapeutic area, medical indication, policies and procedures or other limits for conducting the clinical trial protocol or feasibility study, or other applicable attribute. For example, record 408 for protocol A includes the following attribute fields:
A protocol identifier (Protocol_ID_A);
An identification of the therapeutic area or areas that are the subject of the clinical trial protocol (Therapeutic_Area_A);
A medical indication associated with the clinical trial protocol (Indication_A);
Policies and procedures applicable to the clinical trial protocol (Policies_A);
An identification of CRO personnel or other personnel that are associated with managing the clinical trial protocol (Personnel_A).

Database associations can facilitate more efficient feasibility study implementation and can be leveraged for use in subsequent clinical trial protocol process stages. In some embodiments, the results can be used in a site start-up process for the clinical trial protocol or for conducting a feasibility study for a different, but similar, clinical trial protocol. For example, the site start-up process can include selecting investigators to conduct the clinical trial protocol. The results can be used to identify the investigator as eligible or otherwise preferable to select to conduct the clinical trial protocol and the document tracking information can be used to determine that part of the necessary documentation has been sent to and received from the investigator for purposes of conducting the clinical trial protocol.

### Second Database Integration and Comparison

As is common with a sophisticated entity engaged in managing clinical trial protocol implementation, various storage techniques have been used to store information collected over the life of the entity. Such storage techniques often include additional databases for storing data using storage techniques that may not provide the full desired benefit to the entity, but the data stored therein is still quite useful and valuable. Certain embodiments provide a process by which such data from these additional databases can be used in systems contemplated herein that provide data relationships useful to the entity, as explained via example previously.

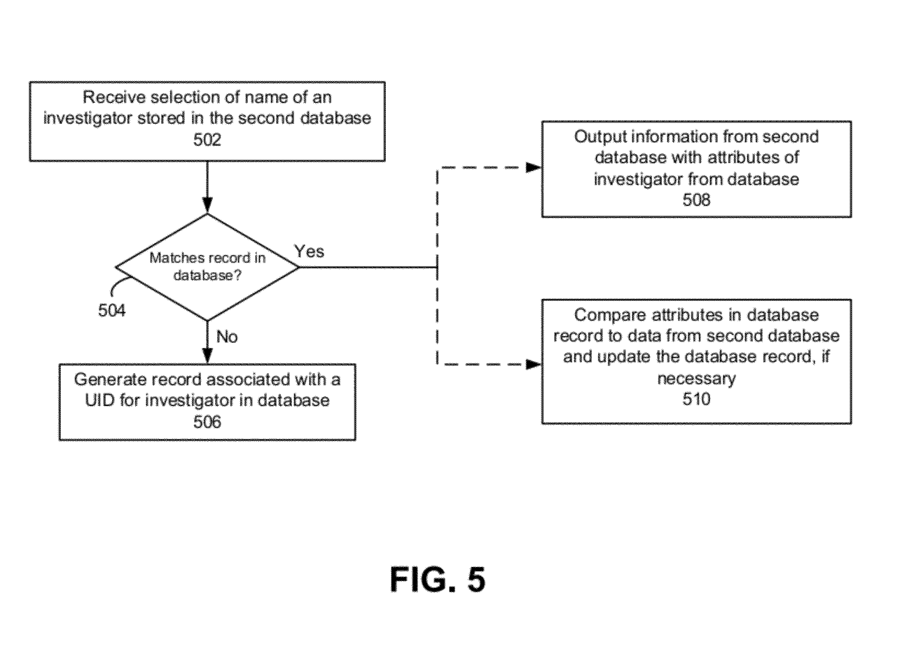

FIG. 5 depicts a process for integrating data from legacy databases according to one embodiment. The process of FIG. 5 is described with reference to FIG. 1, although other implementations are also possible.

In block 502, the database server application 112 receives a selection of a name or other identification of an investigator that is stored in second database 118. In some embodiments, a user via an interface, directly or through computing device 102, with the second database 118 reviews information in that database, including investigator names and data associated with previous clinical trial protocols in which the investigator participated. In response to the user selecting the name of the investigator and a command to integrate the data in the database 114, the computing device 106 can receive the information from the second database 118 through network 116.

After receiving the name of the investigator from the second database 118, the database server application 112 in block 504 determines if the name of the investigator matches a record in the database 114. For example, the database server application 112 can conduct a search of the database using proximate search variables or other techniques in case of slight name misspellings or other differences to determine if a match exists.

If a match does not exist, the database server application 112 in block 506 generates a record for the investigator in the database 114 and includes the data from the second database 118 associated with the investigator in the record. If a match exists, the database server application 112 may end the process or perform additional, optional steps to determine whether to update the data in the database 114 with data from the second database 118. For example, the database server application 112 may output information from the second database 118 along with attributes of the investigator from the database 114, in block 508. In some embodiments, the information and attributes are displayed to a user in a “side-by-side” format to allow the user to determine whether information from the second database 118 should be included in the database 114. Alternatively or additionally, the database server application 112 can compare attributes in the database record to data from the second database and update the database record if necessary, in block 510. For example, the database server application 112 can use de-duplication or other similar technique to avoid updating the database record with overlapping data.

### Measuring a Feasibility Study

One purpose of conducting a feasibility study is to determine if a requisite number of subjects from a subject population can be recruited to participate in a clinical trial protocol. To determine such information, a feasibility study may rely on estimates (based on feedback from investigators that may participate in the clinical trial protocol or other data) on the number of subjects that can be recruited. By using database relationships provided by certain embodiments, these estimates (or any other data point associated with the feasibility study) can be measured against actual data obtained in conducting the clinical trial protocol.

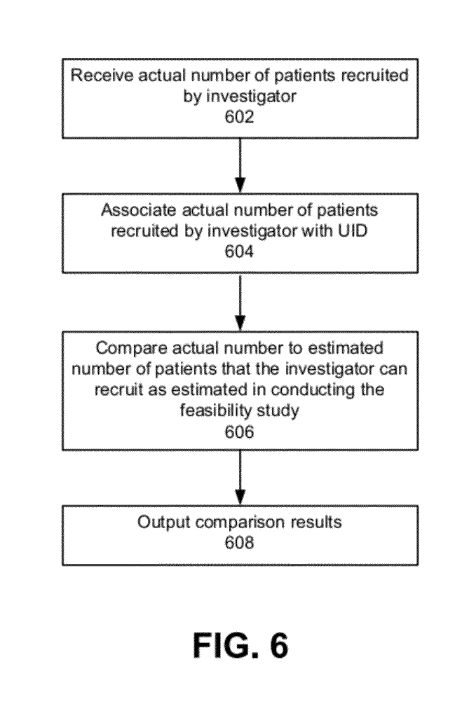

FIG. 6 depicts a process according to one embodiment for measuring a feasibility study by comparing actual number of subjects recruited by an investigator to an estimated number of subjects that the investigator can recruit as determined in a feasibility study. The process is described with reference to FIG. 1, although other implementations are possible. Furthermore, the process performs comparisons on an investigator basis, but the process can be modified to aggregate investigator information per clinical trial protocol and compare an estimated number of subjects to an actual number of subjects on a protocol or country basis.

In block 602, the database server application 112 receives an actual number of subjects recruited by an investigator. This information may be received from user input or by automatically integrating the data from a separate system. In some embodiments, the information is stored in a record for the protocol in database 114.

In block 604, the database server application 112 associates the actual number of subjects recruited by the investigator with the UID in the database 114. In some embodiments, this data is associated with the UID by storing the data in a field in a record for the investigator in the database 114.

In block 606, the database server application 112 compares the actual number of subjects recruited by the investigator to the estimated number of subjects that the investigator can recruit as estimated in conducting the feasibility study. The estimated number of subjects can be associated with the UID, for example in the investigator record as described above in connection with FIG. 3.

In block 608, the database server application 112 outputs the comparison results. In some embodiments, the results are outputted in a web page over the network 116 to the user device 120 that includes a web browser application capable of displaying the comparison results. The user can view the results and determine the effectiveness of the feasibility study on this data point.

### General

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A method comprising:
receiving attributes of an investigator, the attributes comprising an identification of the investigator;
associating a unique identifier (UID) with the attributes of the investigator and storing the UID in a database;
receiving a search request comprising a search variable corresponding to at least one attribute of the investigator;
in response to the search request, outputting at least one attribute of the investigator;
receiving a selection for a feasibility study of a clinical trial protocol of the at least one attribute of the investigator outputted; and
tracking, by a computing device executing code, receipt of at least one document from the investigator and associating receipt of the at least one document with the UID in the database, wherein the document is associated with the feasibility study.

2. The method of claim 1, further comprising:
receiving second attributes of a second investigator stored in a second database, the second attributes of the second investigator comprising a second identification of the second investigator, a country of operation for the second investigator and previous clinical trial protocol information of a previous clinical trial protocol in which the second investigator participated, wherein at least one second attribute corresponds with at least one of the attributes of the investigator; and
associating a second UID with the second identification of the second investigator and storing the second UID and second attributes in the database,
wherein at least one of the second attributes corresponds to the search variable,
wherein a second attribute of the second investigator is outputted in response to the search request.

3. The method of claim 2, wherein receiving the second attributes of the second investigator stored in the second database comprises receiving the second attributes of the second investigator stored in the second database that is a legacy database that is remote from the database.

4. The method of claim 1, wherein the at least one document comprises a confidentiality agreement, wherein tracking the receipt of the at least one document from the investigator comprises:
determining that the receipt of the executed confidentiality agreement is overdue; and
outputting a notification that the receipt of the executed confidentiality agreement is overdue.

5. The method of claim 1, wherein the at least one document comprises a survey, the method further comprising:
tracking, by the computing device, receipt of a completed survey from the investigator and associating the completed survey with the UID in the database, the completed survey comprising an estimated number of subjects that the investigator can recruit for the clinical trial protocol.

6. The method of claim 5, wherein the completed survey is associated with a type of feasibility study.

7. The method of claim 5, further comprising:
receiving an actual number of subjects recruited by the investigator in conducting the clinical trial protocol;
comparing the actual number of subjects to the estimated number of subjects; and
outputting a result of comparing the actual number of subjects to the estimated number of subjects.

8. The method of claim 1, wherein the at least one document is a confidentiality agreement,
wherein associating receipt of the at least one document with the UID in the database comprises associating a flag with the UID, the flag indicating receipt of a signed copy of the confidentiality agreement from the investigator,
wherein outputting the identification of the investigator and the receipt of the at least one document comprises outputting the flag indicating receipt of the signed copy of the confidentiality agreement.

9. The method of claim 8, wherein the flag comprises a date on which the signed copy of the confidentiality agreement is received.

10. The method of claim 1, wherein the identification of the investigator and the receipt of the at least one document are capable of being used in a site start-up process comprising selecting at least the investigator to conduct the clinical trial protocol and noting that the executed confidentiality agreement has been received from the investigator.

11. The method of claim 1, wherein associating the UID with the attributes of the investigator and storing the UID in the database comprises associating the UID with the attributes of the investigator and storing the UID in the database that is a customer relationship management (CRM) database.

12. The method of claim 1, further comprising:
associating the UID with a record for the clinical trial protocol, the record for the clinical trial protocol comprising:
a therapeutic area identifier; and
a medical indication identifier.

13. The method of claim 1, further comprising:
in response to receiving the selection, for the feasibility study of the clinical trial protocol, of the at least one attribute of the investigator outputted, associating the UID with a clinical trial protocol record.

14. A system comprising:
a first database comprising a first non-transitory computer-readable medium for (i) storing a first unique identifier (UID) associated with attributes of a first investigator contacted in connection with a feasibility study of a clinical trial protocol and a flag indicating receipt of an executed confidentiality agreement from the first investigator, and (ii) associating the first UID with a record of the clinical trial protocol, wherein the attributes of the first investigator comprise an identification of the first investigator;
a second database comprising a second non-transitory computer-readable medium for storing second attributes of a second investigator associated with a previous record of a previous clinical trial protocol in which the second investigator participated; and
a database server application stored on the first non-transitory computer-readable medium, the database server application being executable by a processor to:
receive the second attributes of the second investigator;
associate a second UID with the second attributes of the second investigator and with the previous record in the first database; and
track receipt of a second executed confidentiality agreement from the second investigator.

15. The system of claim 14, wherein the database server application is further executable by the processor to track receipt of the executed confidentiality agreement from the first investigator by:
determining that the receipt of the executed confidentiality agreement is overdue; and
outputting a notification that the receipt of the executed confidentiality agreement is overdue.

16. The system of claim 14, wherein the first database is a customer relationship management (CRM) database and the second database is a legacy database that is remote from the first database.

17. The system of claim 14, wherein the database server application is further executable by the processor to:
track receipt of a completed survey from the first investigator and associate the completed survey with the first UID in the database, the completed survey comprising an estimated number of subjects that the investigator can recruit for the clinical trial protocol; and
compare the estimated number of subjects to an actual number of subjects recruited by the first investigator in conducting the clinical trial protocol.

18. The system of claim 14, wherein the record for the clinical trial protocol and the previous protocol record each comprise:
a therapeutic area; and
a medical indication.

19. A non-transitory computer-readable medium tangibly embodying executable code, the code comprising:
code for receiving attributes of an investigator, the attributes comprising an identification of the investigator;
code for associating a unique identifier (UID) with the attributes of the investigator and storing the UID in a database;
code for receiving a search request comprising a search variable corresponding to at least one attribute of the investigator;
code for in response to the search request, outputting at least one attribute of the investigator;
code for receiving a selection for a feasibility study of a clinical trial protocol of the at least one attribute of the investigator outputted; and
code for tracking receipt of at least one document from the investigator and associating receipt of the at least one document with the UID in the database.

20. The non-transitory computer-readable medium of claim 19, further comprising:
code for receiving second attributes of a second investigator stored in a second database; and
code for associating, in the database, a second UID with the second attributes of the second investigator and a previous clinical trial protocol attributes of a previous clinical trial protocol in which the second investigator participated, wherein at least one previous clinical trial protocol attribute corresponds to at least one attribute of the clinical trial protocol corresponding to the search variable,
wherein code for, in response to the search request, outputting the identification of the investigator comprises code for outputting a second identification for the second investigator.

21. The non-transitory computer-readable medium of claim 19, further comprising:
code for receiving second attributes of a second investigator stored in a second database, the second attributes comprising a country of operation for the second investigator and previous clinical trial protocol information of a previous clinical trial protocol in which the second investigator participated, wherein at least one second attribute corresponds with at least one of the attributes of the investigator; and
code for associating a second UID with the second attributes of the second investigator and storing the second UID and second attributes in the database,
wherein the at least one of the second attributes corresponds to the search variable,
wherein a second attribute of the second investigator is outputted in response to the search request.

22. The non-transitory computer-readable medium of claim 19, wherein the non-transitory computer-readable medium is in the database that is a customer relationship management (CRM) database.

23. The non-transitory computer-readable medium of claim 19, further comprising:
code for associating the UID with a record for the clinical trial protocol, the record for the clinical trial protocol comprising:
a therapeutic area identifier; and
a medical indication identifier.

24. The non-transitory computer-readable medium of claim 19, wherein the at least one document comprises a confidentiality agreement, wherein code for tracking the receipt of the at least one document from the investigator comprises:
code for determining that the receipt of the executed confidentiality agreement is overdue; and
code for outputting a notification that the receipt of the executed confidentiality agreement is overdue.

25. The non-transitory computer-readable medium of claim 19, wherein the identification of the investigator and association of the receipt of the at least one document with the UID in the database are capable of being used in a site start-up process comprising selecting at least the investigator to conduct the clinical trial protocol and noting that the at least one document has been received from the investigator.
